(19) United States
(12) Patent Application Publication
(10) Pub. No.: US 2011/0071051 A1
(43) Pub. Date: Mar. 24, 2011

(54) BIOCHIP FOR FRATIONATING AND DETECTING ANALYTES

(75) Inventors: David Halter, Eindhoven (NL); Ralph Kurt, Eindhoven (NL); Roel Penterman, Eindhoven (NL); Emiel Peeters, Eindhoven (NL); Dirk Jan Broer, Geldrop (NL)

(73) Assignee: KONINKLIJKE PHILIPS ELECTRONICS N.V., EINDHOVEN (NL)

(21) Appl. No.: 12/993,106

(22) PCT Filed: May 19, 2009
(86) PCT No.: PCT/IB09/52089

§ 371 Date: Nov. 17, 2010

(30) Foreign Application Priority Data
May 27, 2008 (EP) 08104112.1

(51) Int. Cl. C40B 30/04; C40B 60/12; C40B 40/04; C40B 30/00

(52) U.S. Cl. 506/9; 506/39; 506/15; 506/7

(57) ABSTRACT

The present invention relates to a bio chip for fractionating and detecting analytes, such as proteins, protein-complexes, metabolites, glycoproteins, peptides, DNA, RNA, lipids, fatty acids, carbohydrates and/or other ampholytes.

### FIELD OF THE INVENTION

The present invention is directed to the field of microfluidic devices for the separation and detection of analytes, such as proteins, metabolites, glycoproteins and/or peptides.

### BACKGROUND OF THE INVENTION

Antibody arrays represent one of the high-throughput techniques that are able to detect multiple proteins and antigens simultaneously. These arrays can be used for example for the measurement of changes in expression of disease-related proteins or posttranslational modifications. This allows for diagnosis, prognosis, measurements of drug response, characterization of signaling pathways, and testing for modifications associated with disease development and progression.

Many different antibody array technologies have been developed, each with particular advantages, disadvantages, and optimal applications. The methods have been demonstrated on various sample types, such as serum, plasma, and other bodily fluids; cell culture supernatants; tissue culture lysates; and resected tumor specimens.

However, the use of antibody microarrays is still challenging due to several limitations:
lower accuracy and reproducibility than clinical immunoassays,
limited dynamic ranges of 2 or 3 orders of magnitude and
the need for high-affinity and specific antibodies for target antigens.
Furthermore, the linearity range of such assays depends on the antibody-antigen affinity, whereas the linearity can only be achieved when the concentration of the analyte and antibody matches the affinity constant.

Manual pre-fractionation of a sample (for example according to size, charge, isoelectric point, polarity, . . . ) is a means to reduce the sample complexity and by that decrease the problem of specificity and cross-reactivity. However, this is very labour intensive, requires manual handling steps between fractionation and detection and is therefore prone to errors.

US 2006/0292649 A1 proposes a biochip wherein one or more analytes, such as proteins of a biological sample, are resolved by isoelectric focusing in a capillary. According to US 2006/0292649 A1 the resolved analytes are immobilized in the capillary by photomimmobilization and detection agents, such as antibodies, are flowed through the capillary which bind to or interact with the analytes, forming antibody-protein complexes. Subsequently, a chemiluminescent substrate is flowed through the capillary and detected with a photon detector.

US 2006/0292558 A1 describes a biochip wherein one or more analytes are resolved by isoelectric focusing in a capillary. Afterwards a serum from a human or non-human subject under analysis is flowed through the capillary and antibodies specific to the immobilized analytes bind to the analytes. Subsequently, a secondary antibody including a detectable marker is introduced, and binds to the immobilized antibody-analyte complexes. By means of the detectable markers, the locations of the antibody-analyte complexes are detected.

However, the biochips disclosed in US 2006/0292649 A1 and US 2006/0292558 A1 require a relatively big analyte volume. As a result, antibodies with a high affinity or a high amount of antibodies with a low affinity must be used, which is in both cases expensive. Furthermore, the antibodies will encounter many different analytes (basically each different antibody species will come in contact with all analyte proteins present in the sample) and therefore cross-reactivity cannot be excluded. Moreover, the photo-immobilization of the analytes to the capillary might disturb analyte/antibody binding, for example if the not well defined immobilization site is identical to the antibody binding site, and therefore decrease sensitivity and accuracy.

The object of the present invention is to overcome the mentioned above problems, to increase the analyte concentration, the accuracy and reproducibility and to provide a fast, improved and automatable solution.

### SUMMARY OF THE INVENTION

The present invention relates to a biochip for fractionating and detecting analytes, such as proteins, protein-complexes, metabolites, glycoproteins, peptides, DNA, RNA, lipids, fatty acids, carbohydrates and/or other ampholytes, comprising
an isoelectric focusing channel having a pH gradient between a first pH value (pH1) and a second pH value (pH2),
an anode-cathode pair, whereas the isoelectric focusing channel is at least partially arranged between the anode and the cathode of the anode-cathode pair, in particular to enable isoelectric focusing of analytes in the isoelectric focusing channel,
   a microfluidic sample channel connected or connectable to the isoelectric focusing channel, and
   at least one detection unit comprising
   a microfluidic buffer reservoir,
   a first and a second flow barrier, and
   a microfluidic detection chamber,

whereas the isoelectric focusing channel is connectable to the buffer reservoir by opening the first flow barrier and to the detection chamber by opening the second flow barrier, whereas the first and the second flow barrier are arranged on opposite sides of the isoelectric focusing channel.

The first and the second flow barrier have for example the advantage that the sample does not interact with a capture probe in a detection chamber during isoelectric focusing. This is in particular advantageous, if the biochip comprises several detection units for detecting post-translational protein modifications having different isoelectric points, since the post-translational protein modifications can first be separated by isoelectric focusing and then for example be detected by binding to same antibodies located in different detection chambers.

Within the scope of the present invention, the term “pH gradient between a first pH value (pH1) and a second pH value (pH2)” can not only mean that the pH value continuously, for example linearly or exponentially, increases (or decreases) from a first pH value (pH1) to a second pH value (pH2), but also that the pH value incrementally, for example stepwise or stairwise, increases (or decreases) from a first pH value (pH1) to a second pH value (pH2).

For example pH gradient between a first pH value (pH1) and a second pH value (pH2) according to the invention may be realized by at least two, in particular several, gels (gel pads) of which each gel has a particular pH value, wherein the gels are aligned with respect to each other to that effect the pH value increases (or decreases) from gel to gel in the alignment.

According to the invention, the gels can thereby adjacently be aligned. However, within the scope of the present invention it is also understood as pH gradient, if between two gels, in particular between all gels, a fluid, for example water or a buffer, is positioned. Insofar the pH value of the gels increases (or decreases) from gel to gel in the alignment, such an arrangement of, in particular alternating, gels and fluids is also understood as pH gradient within the scope of the present invention, if a liquid has a pH value, which is not between the pH values of the neighboring gels.

The term “micro fluidic” denotes within the context of the present invention that the means characterized by this adjective has a volume of the order of micro liters, for example of ≧0.01 μl to ≦50 μl, in particular of ≧0.1 μl to ≦10 μl.

For example, the sample channel and/or the buffer reservoir/s and/or the detection chamber/s and/or the detection probe reservoir/s (explained below) can have a volume of about ≧0.1 μl to about ≦50 μl, in particular of about ≧1 μl to about ≦10 μl, and/or a width of about ≧0.2 mm to about ≦5 mm, in particular of about ≧0.5 mm to about ≦1.5 mm, and/or a height of about ≧1 μm to about ≦500 μm, in particular of about ≧10 μm to about ≦200 μm, and/or a length of about ≧1 mm to about ≦100 mm, for example of about ≧1 mm to about ≦50 mm, in particular of about ≧5 mm to about ≦20 mm. The isoelectric focusing channel can for example have a volume of about ≧0.1 μl to about ≦50 μl, in particular of about ≧1 μl to about ≦10 μl, and/or a width of about ≧0.2 mm to about ≦5 mm, in particular of about ≧0.5 mm to about ≦1.5 mm, and/or a height of about ≧1 μm to about ≦500 μm, in particular of about ≧10 μm to about ≦200 μm, and/or a length of about ≧1 mm to about ≦100 mm, for example of about ≧1 mm to about ≦50 mm, in particular of about ≧5 mm to about ≦20 mm. The anode and cathode can for example comprise, in particular consist of, platinum, gold, copper, aluminum or doped silicon, preferably coated with a platinum layer.

A biochip according to the invention is capable to fractionate a sample via isoelectric focusing (IEF) in several pH ranges and to detect the fractioned analytes in a second step in the detection unit via immunoassay/microarray techniques, for example by binding to (labeled) antibodies.

The pre-fractionation of the sample via isoelectric focusing has the advantage that the amount of contaminants is decreased as contaminants having a different pI range than the analytes of interest are separated, the analytes of interest are up-concentrated and the reaction volume of the binding reaction is decreased. Due to the increased analyte concentration, the lowered contaminant amount and the lowered reaction volume antibodies with lower affinity can be used. Simultaneously, specificity and sensitivity of the detection step is increased. Thus, crossreactivity can be circumvented or tremendously reduced. Furthermore, the biochip according to the invention is automatable and can be used for rapid digital diagnostic testing (RDT). All needed functions are therefore advantageously performed on one chip without manual handling steps, whereby accuracy and reproducibility is advantageously increased. Moreover, a biochip according to the invention advantageously enables the realization of portable biochemical systems for point-of-care testing. The biochip according to the invention therefore provides a portable, automatable, fast and improved assay without manual handling steps and with low time consumption for the operator.

Within the scope of the present invention, the first and the second flow barrier are each in particular arranged on one side of the isoelectric focusing channel that is parallel to the pH gradient, whereas the first and the second flow barrier are positioned opposite to each other.

According to the invention, the pH gradient may be a mobilized or immobilized pH gradient.

Within the scope of one embodiment of the present invention, the isoelectric focusing channel comprises, in particular is filled with, a fluid having a pH gradient between a first pH value (pH1) and a second pH value (pH2) generated by ampholytes. Alternatively, the isoelectric focusing channel comprises, in particular is filled with, a gel(strip) having a pH gradient between a first pH value (pH1) and a second pH value (pH2) generated by ampholytes.

Within the scope of another embodiment of the present invention, the isoelectric focusing channel comprises, in particular is filled with, a gel having a pH gradient between a first pH value (pH1) and a second pH value (pH2), whereas the pH gradient is generated by polymerizing at least two, in particular adjacent, formulations based on (meth)acrylate(s), in particular acrylate(s), such as acrylamide, N,N′-methylenebisacrylamide, hydroxyethylacrylate, polyethyleneglycolacrylate, diethyleenglycol diacrylate and/or triethyleneglycol diacrylate, methacrylates, such as hydroxyethylmethacrylate, polyethyleneglycolmethacrylate, diethyleenglycol dimethacrylate and/or triethyleneglycol dimethacrylate, thiolene(s) and/or epoxides, having one or more pH-buffering subunits. For example, the pH gradient is generated by polymerizing at least two, in particular adjacent, formulations comprising at least

acrylamide monomers of the formula (I):

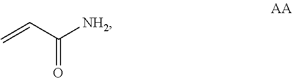

N,N′-methylenebisacrylamide monomers of the formula (II):

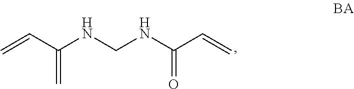

and

monomers, in particular acrylamide monomers, having one or more pH-buffering subunits (immobiline monomers), whereas the formulations comprise different pH-buffering monomers resulting in a different pH value.

For example, the gel may be generated by polymerizing at least three or at least four, in particular a plurality of, adjacent formulations, whereas the pH value increases or decreases from the first to the last formulation. This can be obtained by using a so-called gradient mixer, into which two formulations with different pH values are inserted and mixed in a certain ratio and subsequently injected into the isoelectric focusing area of the biochip. When during filling of the isoelectric focusing area the ratio of the formulations is continuously changed the pH will vary in the filling direction, the pH being closest to the pH of formulation 1 in the beginning and closest to the pH of formulation 2 at the end of the channel. Then the liquid is polymerized to form the pH-gradient gel.

The gel formulations are generally made by mixing ≧0% by weight to ≦20% by weight, in particular ≧2% by weight to ≦10% by weight, of monomers in deionized water. The ratio acrylamide to bisacrylamide is for example in a range of ≧20:1 to ≦100:1, for example about 40:1. To obtain a good buffering capacity at pH of the used immobiline monomers, the concentration of the immobiline monomers can for example be in a range of ≧1 mM to ≦50 mM, for example about 25 mM.

In the biochip, the pH value of the gel or the fluid preferably increases from the area of the anode to the area of the cathode. In particular, the pH gradient of the gel or the fluid is a positive pH gradient and/or increases from the area of the anode to the area of the cathode.

Within the scope of a preferred embodiment of the present invention, the isoelectric focusing channel is provided with an anode and a cathode inlet. By this means, an electric contact of the electrodes and the fluid or gel in the isoelectric focusing channel can simply be achieved by introducing the anode and cathode, respectively into the inlets. Furthermore, the user can advantageously inject ampholytes of his preference through the anode and cathode inlet and thereby generate a custom made pH gradient.

Within the scope of another preferred embodiment of the present invention, the isoelectric focusing channel has no rectangular shape. For example, the width of the isoelectric focusing channel may vary along the pH gradient. In particular, the width of the isoelectric focusing channel may vary along the pH gradient and symmetrically to the axis of the pH gradient or rather the longitudinal axis of the isoelectric focusing channel or rather the axis of the electric flux lines of the anode-cathode pair. Preferably, the isoelectric focusing channel has a greater width at pH ranges where a high amount of analytes is concentrated by isoelectric focusing or rather is expected after isoelectric focusing and has a smaller width at pH ranges where a low amount of analytes is concentrated by isoelectric focusing or rather is expected after isoelectric focusing.

Tuning the geometry of the isoelectric focusing channel by this way advantageously improves the pre-fractionation efficiency and allows easy transfer into a detection chamber arranged at such a position (see FIGS. 3a, 3b and figure description).

Within the scope of the present invention, the buffer reservoir preferably comprises at least one buffer. For applying a pressure to the buffer, the buffer reservoir is for example connected to a pressure means.

By such an arrangement, it is possible to transfer the analyte from the isoelectric focusing channel into the detection chamber by applying a pressure to the buffer in the buffer reservoir, opening the flow barriers and flushing the buffer through the isoelectric focusing channel into the detection chamber.

The detection chamber preferably comprises at least one capture probe. According to the invention, a capture probe is capable to interact with the analyte, for example via antibody-antigen, protein-protein, protein-metabolite, DNA-sense/antisense, RNA-DNA, RNA-RNA or receptor-ligand interaction. A capture probe may be a capture antibody, a capture antigen, a capture protein, a capture metabolite, an oligo-DNA, an oligo-RNA or another molecule having a high affinity to an analyte, for example a single chain variable fragments (scFv), biotin or avidin. The capture probe may also be a suitable/matching topography/molecular imprint technology as known in the art.

Preferably, the capture probe is immobilized to the biochip, in particular to the wall/s, for example the side, bottom and/or top wall/s, of the detection chamber. For example, the capture probe is covalently attached to biochip in a modular way by simple chemistry (for example click chemistry). This advantageously allows to use the biochip according to the invention in a flexible way for many purposes. Alternatively, the capture probe is adsorbed/physisorbed to surface, or sterically and/or kinetically and/or magnetically trapped, or embedded in gel/gel-matrix.

Within the scope of a further preferred embodiment of the present invention, the detection chamber or at least one, in particular each, detection chamber of a set of multiple detection chambers comprises at least two or at least three, for example at least four or at least five or at least six, in particular a plurality of, different capture probes. In a preferred embodiment the capture probes are arranged separated form each other, in particular in different/individual spots, for example like an array/microarray.

Advantageously, in this way several analytes, for example proteins, characterized by an identical pI value can be assayed, in particular distinguished and detected, simultaneously in a single run.

Within the scope of the present invention, the detection of analytes can be achieved by sandwich assay/s as well as competitive assay/s. The detection is thereby preferably carried out optically, for example by using fluorescence, surface plasmon resonance or evanescent field detection.

A detection probe, preferably a labeled detection probe, for example a labeled detection antibody, can be applied to the analytes by several ways:

In one embodiment of the present invention, the buffer reservoir comprises at least one detection probe. Thereby the detection probe can bind directly to the analyte, for example the protein, after isoelectric focusing and after opening the first valves but before reaching the capture probe in the detection chamber.

In another embodiment, the detection chamber comprises at least one detection probe.

In yet another embodiment of the present invention, the detection unit further comprises an, in particular microfluidic, detection probe reservoir, whereas the detection probe reservoir is connected or connectable by opening a third flow barrier to the detection chamber. Thereby, the detection probe reservoir preferably comprises at least one detection probe.

Within the scope of these three mentioned above embodiments, the sample channel and/or the buffer reservoir and/or the detection chamber and/or the detection probe reservoir can be provided with an inlet and/or a further flow barrier, for example a septum, through which the detection probe can be inserted manually or automatically, to allow the detection of user defined analytes and/or the removal of fractionated analytes.

These means have the advantage that the addition the detection probe may be achieved by forming a covalent bond (for example by simple click-chemistry, cross-linking, NHS-chemistry or surface grafting), an adsorption, or a DNA/RNA-oligo-interactions, allowing a versatile use of the biochip according to the invention.

Preferably, the buffer reservoir and the detection chamber or the buffer reservoir and the detection probe reservoir are provided with inlets and/or outlets and/or flow barriers. By this means the capture probe area can be washed, for example after applying the detection probe, by flow of a washing buffer from the buffer reservoir through the detection chamber. Within the scope of a preferred embodiment of the present invention, the detection chamber and/or the detection probe reservoir is connected, for example via an outlet, and/or connectable, for example by opening a flow barrier, to a waste chamber, in particular for collecting the washing buffer after washing.

Within the scope of a further preferred embodiment of the present invention, the biochip according to the invention comprises at least two or at least three, for example at least four or at least five or at least six, in particular a plurality of, detection units positioned, in particular well separated from each other, at different pH ranges of the pH gradient of the isoelectric focusing channel. For example, each detection unit is positioned at a different pH range having a width in a range of a hundreds pH value to 2 pH units, preferably of 5 hundreds pH value to 1 pH unit, most preferably of a tenth pH unit to 0.5 pH units. Moreover, according to the invention a detection unit is for example spaced from the neighboring detection unit by a hundreds pH value to 4 pH units, preferably by 5 hundreds pH value to 2 pH units, most preferably by a tenth pH unit to 1 pH unit. However, within the scope of the present invention, it is possible that several detection units are positioned within a range of 1 pH unit.

By other words, each of the detection units is characterized by a pre-defined, in particular narrow, pI range. For example, the pI range at of one detection unit has a width of about a tenth pI value.

By this means only proteins in a very narrow pI range can enter a dedicated detection chamber. This has the advantage that many analytes characterized by several pI values can be assayed, in particular distinguished and detected, simultaneously in a single run.

A post-translational modification can change the isoelectric point of an analyte, in particular a protein or protein-complex. Therefore, the different species of modified and unmodified analyte would be focused at a different pI during isoelectric focusing. By isoelectric focusing the different species can therefore be separated and detected in different detection units of the biochip according to the invention, for example by the same or a different antibodies.

For example, Mitogen-activated protein kinase 1 (also known as ERK2) can by be separated and detected by a biochip according to the invention, is. Mitogen-activated protein kinase 1 is a serine/threonine kinase that phosphorylates MAP2 and myelin basic protein. Mitogen-activated protein kinase 1 and is a member of the Mitogen-activated protein (MAP) kinase family. Mitogen-activated protein kinases, also known as extracellular signal-regulated kinases (ERKs), act as an integration point for multiple biochemical signals and are involved in a wide variety of cellular processes such as proliferation, differentiation, transcription regulation and development. Mitogen-activated protein kinase 1 in particular is an important proximal component of the Mitogen-activated protein kinase pathway involved in transmitting the signals from growth factors, neurotransmitters and hormones at the cell surface to the transcriptional events in the nucleus. The activation of Mitogen-activated protein kinase 1 requires its phosphorylation by upstream kinases. Thereby, Mitogen-activated protein kinase 1 is activated by mitogen-activated protein kinase kinase 2 (also known as MAP2K2 or MEK2), which phosphorylates neighboring threonine 183 and tyrosine 185 residues, whereas the structures of inactive, unphosphorylated and active, phosphorylated structure was published 1997 by Canagarajah et al. With standard antibody based immuno-detection techniques these two species can not be distinguished and quantified in a simple manner. Therefore disease related correlations can not easily be detected by known devices and methods. But, as the unphosphorylated form has a pI value of 6.523 and the phosphorylated form has a lower pI of 6.373, it is advantageously possible to separate the two forms by a biochip according to the invention and to detect the separated forms in different detection chambers by the same antibody.

Furthermore, the biochip according to the present invention advantageously allows the comparison of the intensities of the signals of several/different analytes, such as proteins, or rather the detection of patterns of presence or absence, respectively, of several/different analytes in the same sample. Moreover, ratios between different analytes, such as proteins, in particular post-translational modified and unmodified proteins, can be assayed. This enables a quantitative and/or semi-quantitative analysis of the ratio of modified and unmodified analyte. Advantageously, the biochip according to the invention can thereby be used for detecting, in particular “fingerprinting”, certain diseases.

However, within the scope of the present invention, the capture probes and/or the corresponding detection probes of the different detection units can at least partially differ to each other.

According to a preferred embodiment the biochip comprises a set of capture and detection probes, in particular a set of capture and detection antibodies, for example an antibody array, distinguishing between different post-translational modifications, for example phosphorylation and ubiquitination, of an analyte, in particular a protein. This advantageously also allows a (semi)-quantitative determination of the ratio of modified and unmodified analyte.

According to another preferred embodiment the biochip comprises a set of capture and detection probes, in particular a set of capture and detection antibodies, for example an antibody array, specific for several proteins and/or enzymes belonging to a certain signaling pathway, for example a pathway up or down regulated in certain diseases.

Generally, all known flow barriers for microfluidic channels, for example microvalves, can be used for a biochip according to the invention.

Within the scope of another embodiment of the present invention, at least one flow barrier is a hydrophobic stop barrier. In particular, the first, the second and/or the third flow barrier of a detection unit is a hydrophobic stop barrier.

A hydrophobic stop barrier can be achieved by coating at least one area inside a capillary, such as the sample channel or a detection chamber or a buffer reservoir or a detection probe reservoir, with a water repellant agent, such as 1H,1H,2H,2H-perfluoroalkyltrihalogenosilanes, for example 1H,1H,2H,2H-perfluorohexyltrichlorosilane, 1H,1H,2H,2H-perfluorooctyltrichlorosilane, 1H,1H,2H,2H-perfluorodecyltrichlorosilane and/or 1H,1H,2H,2H-perfluorododecyltrichlorosilane, in particular 1H,1H,2H,2H-perfluorodecyltrichlorosilane, and/or 1H,1H,2H,2H-perfluoroalkyltrialkoxysilanes, for example 1H,1H,2H,2H-perfluorohexyltrimethoxysilane, 1H,1H,2H,2H-perfluorooctyltrimethoxysilane, 1H,1H,2H,2H-perfluorodecyltrimethoxysilane, 1H,1H,2H,2H-perfluorododecyltrimethoxysilane, 1H,1H,2H,2H-perfluorohexyltriethoxysilane, 1H,1H,2H,2H-perfluorooctyltriethoxysilane, 1H,1H,2H,2H-perfluorodecyltriethoxysilane and/or 1H,1H,2H,2H-perfluorododecyltriethoxysilane, in particular 1H,1H,2H,2H-perfluorodecyltrimethoxy-silane and/or 1H,1H,2H,2H-perfluorodecyltriethoxysilane, and/or Teflon (poly-perfluoroethylene) based compounds, for example Teflon AF1600, and/or a compound of the formula (III):

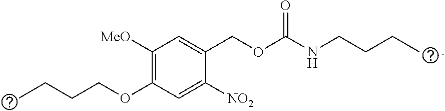

Such a coating ensures that a liquid, for example the sample, a fraction of the sample or a buffer or a liquid comprising a detection probe or a gel formulation, is stopped at the position of the coating (see FIGS. 6a to 6c and figure description). Depending on the used water repellant agent, the hydrophobic stop barrier can be actuated/opened by applying a pressure on the stopped liquid, for example by a pressure means, by applying a high voltage on the stopped liquid, by changing/increasing the temperature, by temporarily decreasing the cross section dimension of the capillary and/or by ultra violet radiation. For example a hydrophobic compound of the general formula (III) decomposes under radiation with ultra violet light to a hydrophilic compound.

Within the scope of a specially preferred embodiment of the present invention, the biochip comprises a first and a second substrate, whereas the first substrate is slidably abutting the second substrate, whereas the channel/s, reservoir/s, chamber/s and flow barriers of the biochip are realized, in particular at least partially, by recesses in the abutting faces of the first and a second substrate, whereas the flow barriers are openable and closable by shifting one of the substrates with respect to the other from a first to a second position. For example, the isoelectric focusing channel and the flow barriers are realized by in alternation overlapping recesses in the abutting faces of the first and a second substrate.

According to the present invention, the pH gradient of the isoelectric focusing channel can thereby not only realized by filling the isoelectric focusing channel formed by the in alternation overlapping recesses in the abutting faces of the first an the second substrate with a liquid or gel having a continuous pH gradient between a first pH value (pH1) and a second pH value (pH2), but also by filling at least two recesses of the in alternation overlapping recesses in the abutting faces of the first and a second substrate with gels of different pH values, whereas the pH values of the gels increase (or decrease) from gel to gel. Thereby, the other recesses can be filled with a liquid, such as water or a buffer, which for example may have a pH value which is not between the pH values of the neighboring gels.

Within the scope of one embodiment of the present invention, only the recesses in the second substrate forming the isoelectric focusing channel by alternately overlapping with recesses in the first substrate or only the recesses in the first substrate forming the isoelectric focusing channel by alternately overlapping with recesses in the second substrate, in particular only the recesses in the second substrate, are filled with gels of particular pH values, whereas the pH value increases (or decreases) from gel to gel, whereas the recesses in the other substrate, in particular the first substrate, are filled with a liquid, such as water or a buffer.

According to the present invention, preferably both the recesses in the first substrate and the recesses in second substrate are spaced to recesses in the same substrate.

The inlet/s is/are for example realized by an inlet hole or holes in the first and/or the second substrate merging into a recess in the substrate.

For example, the flow barrier, the isoelectric focusing channel, the buffer reservoirs, the detection chambers of the biochip are realized by that,
the first substrate comprises at least one recess pair having a first and a second recess,
whereas the second substrate comprises at least one recess triplet having a middle recess, a first outer recess and a second outer recess,

whereas the recesses are shaped and arranged to that effect that
in a first position, the first recess of a recess pair overlaps with the middle recess of one recess triplet or with the middle recesses of two neighboring recess triplets, forming the isoelectric focusing channel, and
in a second position, the first recess of a recess pair overlaps with the first outer recess and the middle recess of a recess triplet, whereas the second recess of the recess pair overlaps with the middle recess and the second outer recess of the recess triplet, forming a chamber.

For example, the first substrate comprises at least two or at least three, for example at least four or least five or at least six, in particular a plurality of, recess pairs and the second substrate comprises at least two or at least three, for example at least four or at least five or at least six, in particular a plurality of, recess triplets.

By shifting the first and the second substrate from the first to the second position, the first and the second recess of a recess pair serve as the first and the second flow barrier of the detection unit.

The first outer recess and the second outer recess of a recess triplet thereby serves as buffer chamber and detection chamber, respectively.

In one embodiment of the present invention, at least two recesses selected from the group of first recesses of recess pairs and middle recesses of recess triplets are filled with gels of different pH values, whereas the pH values of the gels increase (or decrease) from gel to gel.

In a preferred embodiment of the present invention, all first recesses of recess pairs are filled with gels of different pH values, whereas the pH values of the gels increase (or decrease) from gel (or recess) to gel (or recess), whereas all middle recesses of recess triplets are filled with a liquid, such as water or a buffer; or all middle recesses of recess triplets are filled with gels of different pH values, whereas the pH values of the gels increase (or decrease) from gel (or recess) to gel (or recess), whereas all first recesses of recess pairs are filled with a liquid, such as water or a buffer.

For additionally realizing the detection probe reservoir/s and third flow barrier/s
the first substrate comprises at least one recess triplet having a first outer, a middle and a second outer recess,
whereas the second substrate comprises at least one recess quartet having a first middle recess, a second middle recess, a first outer recess and a second outer recess,

whereas are shaped and arranged to that effect that
in a first position, the first outer recess of a recess triplet overlaps with the first middle recess of one recess quartet or with the first middle recesses of two neighboring recess quartets, forming the isoelectric focusing channel, and
in a second position, the first outer recess of a recess triplet overlaps with the first outer recess and the first middle recess of a recess quartet, whereas the middle recess of the recess triplet overlaps with the first middle recess and the second middle recess of the recess quartet, whereas the second outer recess of the recess triplet overlaps with the second middle recess and the second outer recess of the recess quartet, forming a chamber.

For example, the first substrate comprises at least two or at least three, for example at least four or at least five or at least six, in particular a plurality of, recess triplets and the second substrate comprises at least two or at least three, for example at least four or at least five or at least six, in particular a plurality of, recess quartets.

By shifting the first and the second substrate from the first to the second position, the middle, the first outer, and the second outer recess of a recess triplet serve as the first, second and third flow barrier of the detection unit.

The first outer, the second middle and the second outer recess of a recess quartet thereby serves as buffer chamber, detection chamber and detection probe reservoir, respectively.

In one embodiment of the present invention, at least two recesses selected from the group of first outer recesses of recess triplets and first middle recesses of recess quartets are filled with gels of different pH values, whereas the pH values of the gels increase (or decrease) from gel to gel.

In a preferred embodiment of the present invention, all first outer recesses of recess triplets are filled with gels of different pH values, whereas the pH values of the gels increase (or decrease) from gel (or recess) to gel (or recess), whereas all first middle recesses of recess quartets are filled with a liquid, such as water or a buffer; or all first middle recesses of recess quartets are filled with gels of different pH values, whereas the pH values of the gels increase (or decrease) from gel (or recess) to gel (or recess), whereas all first outer recesses of recess triplets are filled with a liquid, such as water or a buffer.

In these embodiments of the present invention, the connection between the microfluidic sample channel and the isoelectric focusing channel may be realized by an inlet recess in the second substrate overlapping in the first position with a first recess of a recess pair, or a first middle recess of a recess triplet.

For providing the isoelectric focusing channel with two inlets, for example for injecting gel formulations and/or ampholytes for generating and/or adjusting the pH gradient, the first and the second substrate may each comprise at least one inlet recess and/or inlet hole, whereas the inlet recesses and/or inlet holes are shaped and arranged to that effect that
in the first position,
the inlet recess and/or inlet hole of the first substrate overlaps
with the middle recess of the recess triplet, positioned at one end of the channel formed in the first position, and in particular only overlapped with one first recess of one recess pair, or
with the first middle recess of the recess quartet, positioned at one end of the channel formed in the first position, and in particular only overlapped with one first middle recess of one recess triplet, and
the inlet recess of the second substrate overlaps
with the first recess of the recess pair, which is positioned at the other end of the channel formed in the first position, and in particular overlaps with only one middle recess of one recess triplet, or
with the first outer recess of a recess triplet, which is positioned at the other end of the channel formed in the first position, and in particular overlaps with only one first middle recess of one recess quartet.

Preferably, the inlet recesses of the first and the second substrate do not overlap in the second position a recess of a recess pair, triplet or quartet.

Another subject of the present invention is the use of a biochip according to the invention in
rapid and sensitive detection of proteins, protein-complexes, metabolites, glycoproteins, peptides, DNA, RNA, lipids, fatty acids, carbohydrates and/or other ampholytes in complex biological mixtures, such as blood, saliva, urine,
a testing chip, for example for proteins, protein-complexes, metabolites, glycoproteins, peptides, DNA, RNA, lipids, fatty acids, carbohydrates and/or other ampholytes, for example for on-site (point-of-need) testing or for diagnostics in centralized laboratories or in scientific research,
a biosensor, in particular microfluidic biosensor, used for molecular diagnostics,
a high throughput screening chip for chemistry, pharmaceuticals or molecular biology,
a protein diagnostic biochip for cardiology, infectious diseases, new born screening, oncology, food, environment and/or metabolomics, and/or
a biochip for the detection and quantitation of proteins with posttranslational modifications and/or ratios between modified and unmodified species of the same protein.

### BRIEF DESCRIPTION OF THE DRAWINGS

Additional details, features, characteristics and advantages of the object of the invention are disclosed in the subclaims, the figures and the following description of the respective figures and examples, which—in an exemplary fashion—show several preferred embodiments of a chip according to the invention.

FIG. 1a shows a schematic top view of a biochip according to a first embodiment of the present invention having one detection unit.

FIG. 1b to 1d show enlarged schematic top views of the biochip shown in FIG. 1a.

FIG. 2 shows a schematic top view of a biochip according to a second embodiment of the present invention having multiple detection units.

FIG. 3a shows a schematic top view of a biochip according to a third embodiment of the present invention having an adapted isoelectric focusing channel.

FIG. 3b shows a schematic top view of a biochip according to another form of the third embodiment of the present invention having an adapted isoelectric focusing channel.

FIG. 4a shows a schematic top view of the first position a biochip according to a forth embodiment of the present invention comprising a first and a second substrate.

FIG. 4b shows a schematic cross sectional view of the first position of the biochip shown in FIG. 4a.

FIG. 4c shows a schematic top view of the second position of the biochip shown in FIGS. 4a and 4b.

FIG. 4d shows a schematic cross sectional view of the second position of the biochip shown in FIGS. 4a to 4c.

FIG. 5a shows a schematic top view of the first position a biochip according to a fifth embodiment of the present invention comprising a first and a second substrate.

FIG. 5b shows a schematic top view of the second position a biochip shown in FIG. 5a.

FIGS. 6a to 6c show schematic cross-sectional views of a hydrophobic stop barrier according to the present invention.

### DETAILED DESCRIPTION OF EMBODIMENTS

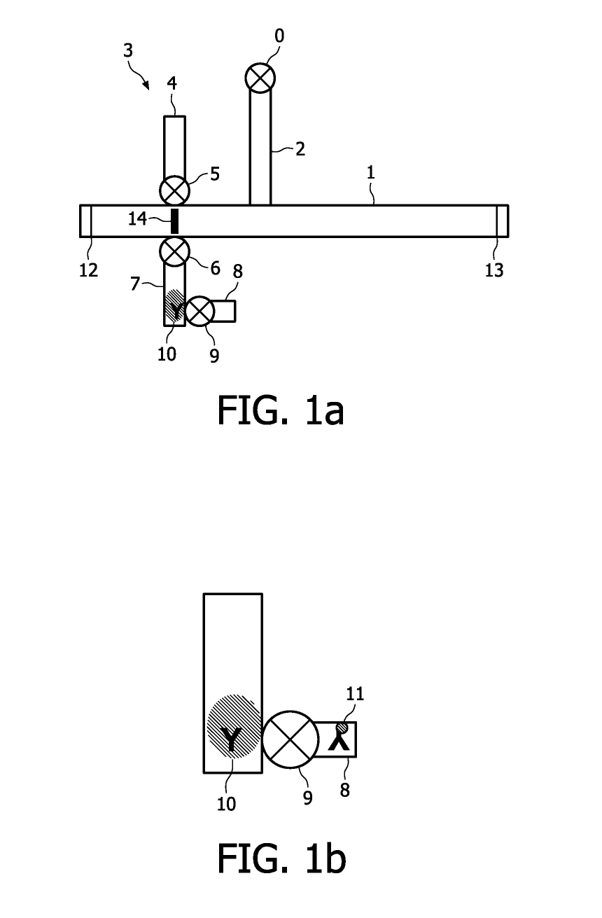

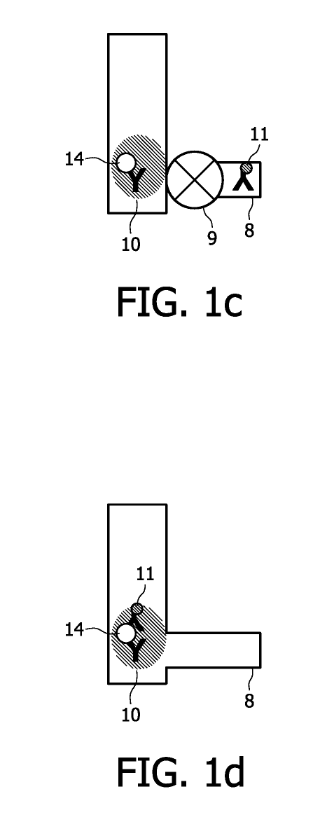

FIG. 1a shows a schematic top view of a biochip according to a first embodiment of the present invention comprising an isoelectric focusing channel 1 having a pH gradient between a first pH value (pH1) and a second pH value (pH2) and a microfluidic sample channel 2. In the embodiment shown in FIG. 1a, the sample channel 2 is positioned in contact with the isoelectric focusing channel 1. By other words, the sample channel 2 is connected to the isoelectric focusing channel 1 and/or merges into the isoelectric focusing channel 1.

However, within the scope of the present invention, it is also possible that the sample channel 2 is designed connectable to the isoelectric focusing channel 1 (not illustrated in FIG. 1a). For example, the sample channel 2 may be connectable to the isoelectric focusing channel 1 by opening a flow barrier.

FIG. 1a shows that according to the present invention, the sample channel 2 is preferably connected (or connectable) to the center part of the isoelectric focusing channel 1.

Furthermore FIG. 1a shows that the sample channel 2 may be provided with an inlet and/or flow barrier 0. By injecting the sample through this inlet and/or opened flow barrier 0, the sample can be applied and reach the isoelectric focusing channel 1.

FIG. 1a shows that the biochip according to the present invention comprises an anode-cathode pair 12, 13. To enable isoelectric focusing of analytes 14 in the isoelectric focusing channel 1, the isoelectric focusing channel 1 is at least partially arranged between the anode 12 and the cathode 13 of the anode-cathode pair 12, 13.

The isoelectric focusing channel 1 is preferably filled with a gel such that a pH gradient is formed in which the isoelectric focusing of the analytes 14 can take place. The pH gradient is for example built up between different pH values in the area of the anode 12 and the area of the cathode 13. Preferably, the pH gradient of the gel is positive and/or increases from the area of the anode 12 to the area of the cathode 13.

To achieve an electric contact of the anode and cathode, respectively with the fluid in the isoelectric focusing channel 1 and to inject gel formulations and/or ampholytes for generating and/or adjusting the pH gradient, the isoelectric focusing channel 1 is preferably provided with a not illustrated anode and a cathode inlet.

Upon applying an electric field between the anode 12 and the cathode 13, the analytes 14 in the sample will at least partially move to a place where their isoelectric point (pI) equals the pH value of the gradient in the isoelectric focusing channel 1. There, the net charge, and therefore the net force on the analyte 14, is zero and all analytes with that respective pI will be concentrated.

For detecting analytes 14 concentrated via isoelectric focusing, the biochip according to the invention comprises at least one detection unit 3. FIG. 1a shows that a detection unit 3 according to the invention may be described as sectioned chamber that virtually crosses the isoelectric focusing channel 1. The detection unit 3 is thereby sectioned into a microfluidic buffer reservoir 4 and a microfluidic detection chamber 7. As it is important that the buffer reservoir 4 and the detection chamber 7 are well separated during the isoelectric focusing, a detection unit 3 according to the invention further comprises a first 5 and a second 6 flow barrier arranged on opposite sides of the isoelectric focusing channel 1. In Particular, the first 5 and the second 6 flow barrier are each arranged on one side of the isoelectric focusing channel 1 that is parallel to the pH gradient. As shown in FIG. 1a, the isoelectric focusing channel 1 can be connected to the buffer reservoir 4 by opening the first flow barrier 5 and to the detection chamber 7 by opening the second flow barrier 6.

The buffer reservoir 4 preferably comprises at least one buffer. After the focusing step flow barriers 5, 6 are opened to allow buffer in the reservoir 4 to transport the analyte 14 to the detection chamber 7. The detection chamber 7 comprises preferably at least one capture probe 10, which binds to the analyte 14.

In the embodiment shown in FIG. 1a to 1d, the detection unit 1 further comprises a detection probe reservoir 8. The detection probe reservoir 8 is in FIGS. 1a to 1d connectable to the detection chamber 7 by opening a third flow barrier 9.

The enlarged schematic top views in FIGS. 1b to 1d show that the detection probe reservoir 8 comprises in this embodiment of the invention at least one detection probe 11, for example a labeled secondary antibody. FIG. 1d shows that after opening the third flow barrier 9, the detection probe 11 can contact and bind to the analyte 14 already bound to the capture probe 10. Afterwards, the capture probe-analyte-detection probe is for example optically detected.

Advantageously, all required sample handling steps are therefore integrated into a single biochip according to the invention.

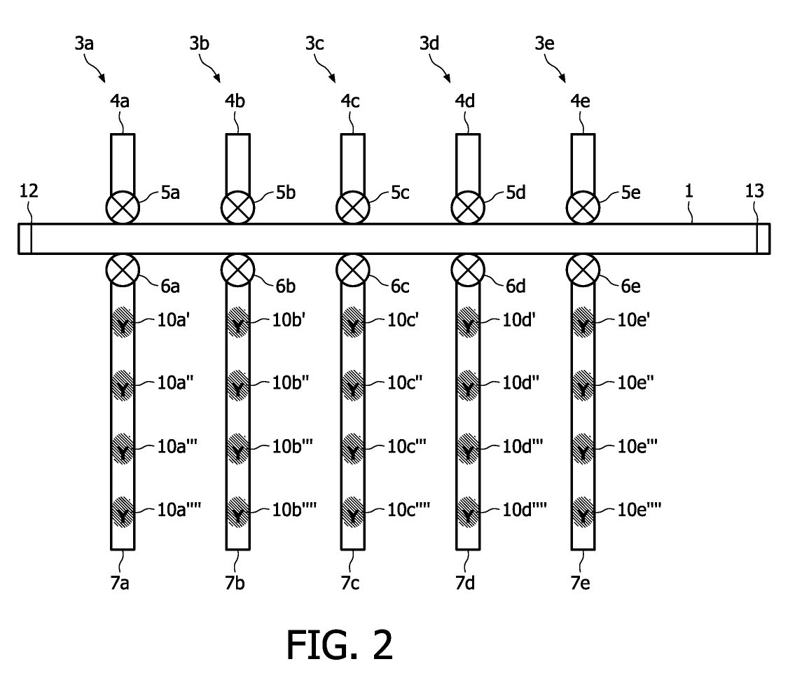

FIG. 2 shows a schematic top view of a biochip according to a second embodiment of the present invention having multiple detection units. In particular, the biochip shown in FIG. 2 comprises five detection units 3a, 3b, 3c, 3d, 3e. These detection units 3a, 3b, 3c, 3d, 3e are positioned at different pH ranges of the pH gradient of the isoelectric focusing channel 1. Thereby, each of the detection units 3a, 3b, 3c, 3d, 3e is characterized by a predefined narrow pI range and is capable of further transporting and detecting a pre-fractionated portion of an analyte mixture characterized by the predefined pI. This has the advantage that many analytes characterized by several pI value can be distinguished and detected simultaneously in a single run.

Moreover FIG. 2 illustrates another preferred embodiment, in which each detection chamber 7a, 7b, 7c, 7d, 7e comprises four different capture probes 10a′, 10a″, 10a′″, 10a″″, . . . , 10e′, 10e″, 10e′″, 10e″″. In this way, several proteins characterized by an identical pI value can be distinguished and detected simultaneously in a single run.

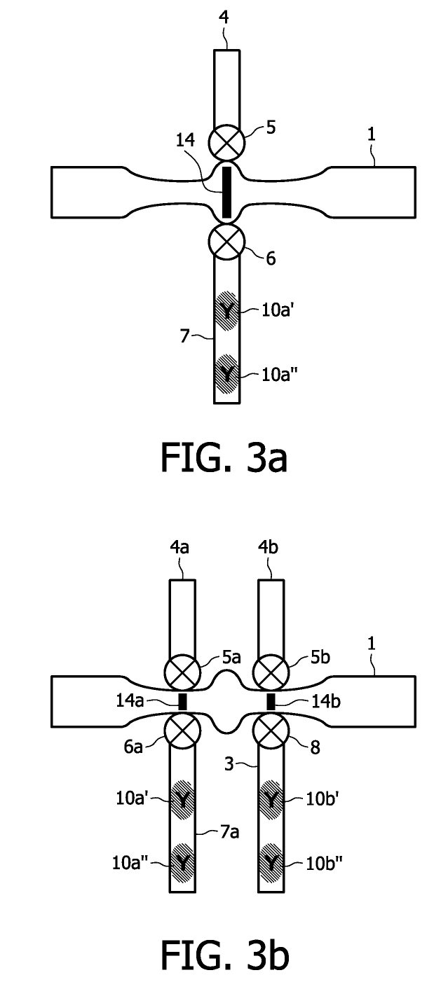

FIGS. 3a and 3b show schematic top views of a biochip according to two forms of a third embodiment of the present invention having an adapted isoelectric focusing channel. As shown in FIGS. 3a and 3b show, the width of the isoelectric focusing channel 1 can vary along the pH gradient and symmetrically to the axis of the pH gradient or rather the longitudinal axis of the isoelectric focusing channel 1 or rather the axis of the electric flux lines of the anode-cathode pair 12, 13. FIG. 3a shows that the isoelectric focusing channel 1 has a greater width at a pH range where a high amount of analytes is concentrated by isoelectric focusing. FIG. 3b shows that the isoelectric focusing channel 1 has a smaller width at pH ranges where a low amount of analytes is concentrated by isoelectric focusing. Tuning the geometry of the isoelectric focusing channel 1 by this way advantageously improves the pre-fractionation efficiency and allows easy transfer into a detection chamber 7 arranged at such a position.

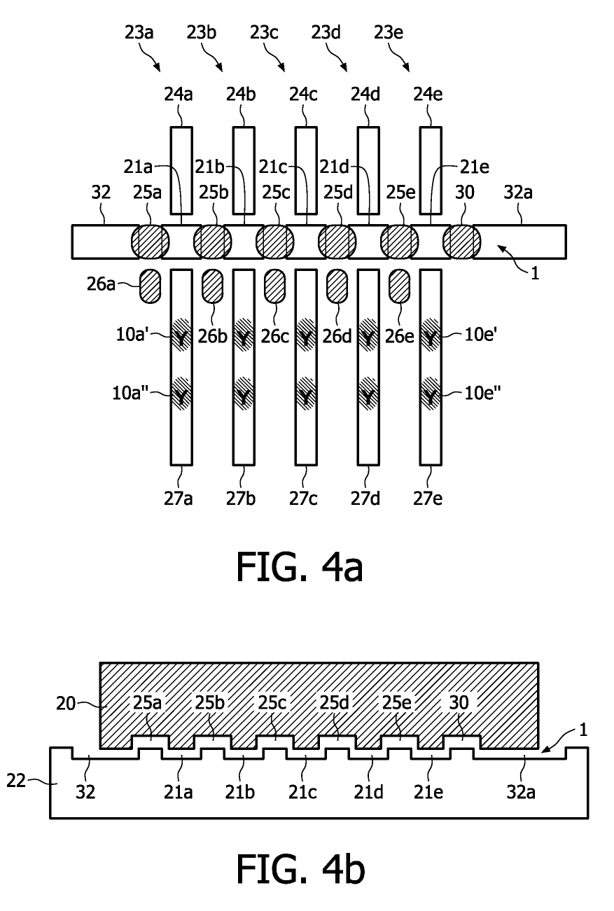

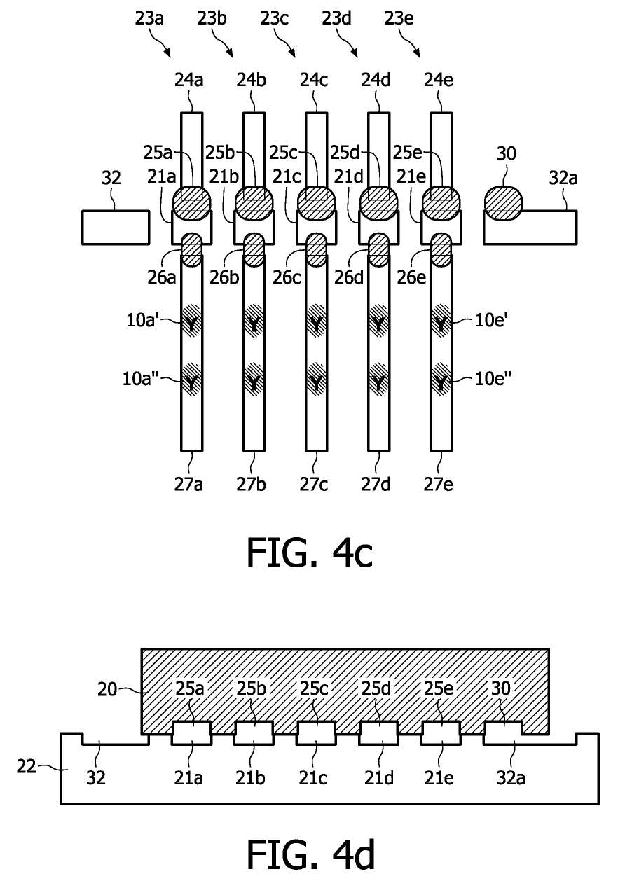

FIGS. 4a and 4b show a schematic top view or rather a schematic cross sectional view of a biochip according to a forth embodiment of the present invention comprising a first (upper) 20 and a second (lower) 22 abutting flat substrate. Thereby the two substrates 20, 22 have a shape which allows to shift the abutting sides of the substrates with respect to each other. In particular, FIGS. 4a and 4b show the arrangement of the first substrate 20 with respect to the second substrate 22 in a first position.

Said substrates 20, 22 comprise a plurality of recesses indicated as 25a, 25b, 25c, 25d, 25e, 26a, 26b, 26c, 26d, 26e in the first substrate 20 and indicated as 21a, 21b, 21c, 21d, 21e, 24a, 24b, 24c, 24d, 24e, 27a, 27b, 27c, 27d, 27e in the second substrate 22, respectively, realizing the flow barriers 25a, 25b, 25c, 25d, 25e, 26a, 26b, 26c, 26d, 26e, the isoelectric focusing channel 21a, 21b, 21c, 21d, 21e, the buffer reservoirs 24a, 24b, 24c, 24d, 24e, the detection chambers 27a, 27b, 27c, 27d, 27e of the biochip.

FIG. 4a shows that the first substrate 20 in particular comprises five recess pairs 25a, 26a, . . . , 25e, 26e having a first 25a, 25b, 25c, 25d, 25e and a second 26a, 26b, 26c, 26d, 26e recess, whereas the second substrate 22 comprises five recess triplets 23a, 23b, 23c, 23d, 23e having a middle recess 21a, 21b, 21c, 21d, 21e, a first outer recess 24a, 24b, 24c, 24d, 24e and a second outer recess 27a, 27b, 27c, 27d, 27e.

Moreover, FIGS. 4a and 4b illustrate that in the first position, the recesses are arranged to that effect that, the first recess 25a of one recess pair 25a, 26a overlaps with the middle recess 21a of one recess triplet 23a and the first recesses 25b, 25c, 25d, 25e of the other recess pairs 25b, 26b, 25c, 26c, 25d, 25d, 25e, 26e overlap with the middle recesses 21a, 21b, 21c, 21d, 21e of two neighboring recess triplets 23a, 23b, 23c, 23d, 23e. In particular, FIGS. 4a and 4b show that the first recesses 25b, 25c, 25d, 25e in the first (upper) substrate 20 overlap with the middle recesses 21a, 21b, 21c, 21d, 21e in the second (lower) substrate 22 in alternation forming a continuous isoelectric focusing channel 1. According to the present invention, during isoelectric focusing the two substrates 20, 22 are aligned with respect to each other in the first position. After isoelectric focusing, the first 20 and the second 22 substrate are shifted, in particular in a planar direction, with respect to each other to a second position. For example, the first (upper) substrate 20 is shifted a bit in x and a bit in y direction with respect to the second (lower) substrate 22. By that substantially the isoelectric focusing channel 1 is interrupted, but at the same time at least one continuous chamber is formed by a recess pair and triplet. This embodiment is therefore a mechanical realization of the flow barriers according to the invention.

The second position of the first 20 and the second 22 substrate is illustrated in FIGS. 4c and 4d. Thereby, FIG. 4c shows a schematic top view and FIG. 4d shows a schematic cross sectional view of the second position of the biochip. As shown in FIGS. 4c and 4d in the second position of this embodiment, the first recess 25a, 25b, 25c, 25d, 25e of a recess pair 25a, 26a, . . . , 25e, 26e overlaps with the first outer recess 24a, 24b, 24c, 24d, 24e and the middle recess 21a, 21b, 21c, 21d, 21e of a recess triplet 23a, 23b, 23c, 23d, 23e, whereas the second recess 26a, 26b, 26c, 26d, 26e of the recess pair 25a, 26a, . . . , 25e, 26e overlaps with the middle recess 21a, 21b, 21c, 21d, 21e and the second outer recess 27a, 27b, 27c, 27d, 27e of the recess triplet 23a, 23b, 23c, 23d, 23e, forming five chambers.

The first outer recess 24a, 24b, 24c, 24d, 24e and the second outer recess 27a, 27b, 27c, 27d, 27e of a recess triplet 23a, 23b, 23c, 23d, 23e thereby serves as buffer chamber and detection chamber, respectively.

Furthermore, FIGS. 4a and 4b show that the first 20 and the second 22 substrate each comprise at least one inlet recess 30, 32, 32a. Thereby, the inlet recess 30 of the first substrate 20 is shaped and arranged to that effect that it overlaps in the first position with the middle recess 21e of a recess triplet 23e positioned at one end of the channel 1 formed in the first position and the inlet recess 32 of the second substrate 22 is shaped and arranged to that effect that it overlaps in the first position with the first recess 25a of the recess pair 25a, 26a, . . . , 25e, 26e positioned at the other end of the channel 1 formed in the first position. However, FIGS. 4c and 4d show that the inlet recesses 30, 32, 32a of the first 20 and the second 22 substrate do not overlap with a recess of a recess pair 25a, 26a, . . . , 25e, 26e or triplet 23a, 23b, 23c, 23d, 23e in the second position.

Moreover, in the embodiment shown in FIGS. 4a to 4b the first recesses 25a, 25b, 25c, 25d, 25e of the recess pairs 25a, 26a, . . . , 25e, 26e are arranged along a first axis and the second recesses 26a, 26b, 26c, 26d, 26e of the recess pairs 25a, 26a, . . . , 25e, 26e are arranged along a second axis parallel to the first axis. Additionally, the middle recess 21a, 21b, 21c, 21d, 21e, the first outer recess 24a, 24b, 24c, 24d, 24e and the second outer recess 27a, 27b, 27c, 27d, 27e of a recess triplet 23a, 23b, 23c, 23d, 23e are arranged along a third axis. FIGS. 4a and 4c show, that the third axes of several recess triplets 23a, 23b, 23c, 23d, 23e are parallel to each other. Moreover, FIGS. 4a and 4c show the middle recesses 21a, 21b, 21c, 21d, 21e of several recess triplets 23a, 23b, 23c, 23d, 23e are arranged along a forth axis, the first outer recesses 24a, 24b, 24c, 24d, 24e of several recess triplets 23a, 23b, 23c, 23d, 23e are arranged along a fifth axis and the second outer recess 27a, 27b, 27c, 27d, 27e of several recess triplets 23a, 23b, 23c, 23d, 23e are arranged along a sixth axis, whereas the forth, the fifth and the sixth axis are parallel to each other and parallel to the first axis. In the embodiment shown in FIGS. 4a to 4d, the first, second, forth, fifth and sixth axis forms the same angle, in particular a rectangular angle, with the third axes.

FIGS. 4a and 4d show that in the first position, the first axis through the first recesses 25a, 25b, 25c, 25d, 25e of the recess pairs 25a, 26a, . . . , 25e, 26e is arranged parallel above or under the forth axis through the middle recesses 21a, 21b, 21c, 21d, 21e of the recess triplets 23a, 23b, 23c, 23d, 23e. FIGS. 4c and 4d show that in the second position, the axis through the first 25a, 25b, 25c, 25d, 25e and the second 26a, 26b, 26c, 26d, 26e recesses of a recess pairs 25a, 26a, . . . , 25e, 26e is arranged parallel above or under the third axis through the middle recess 21a, 21b, 21c, 21d, 21e, the first outer recess 24a, 24b, 24c, 24d, 24e and the second outer recess 27a, 27b, 27c, 27d, 27e of a recess triplet 23a, 23b, 23c, 23d, 23e. The switch between the first and the second position is thereby achieved by displacing the first substrate 20 with respect to the second substrates 22 for a certain distance, for example corresponding to the width of the first recess in the direction of the first axis, along the first or rather forth axis and for another certain, for example corresponding to half the width of the first recess in the direction of the third axis, along the third axis.

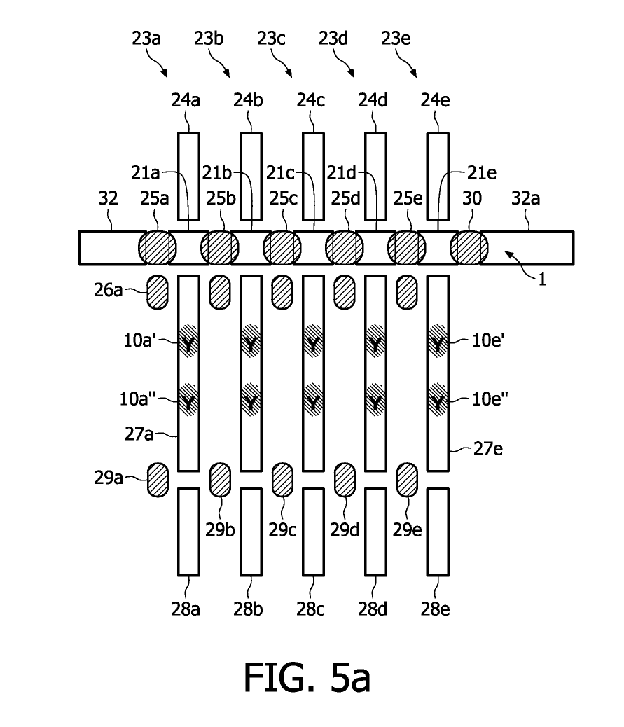

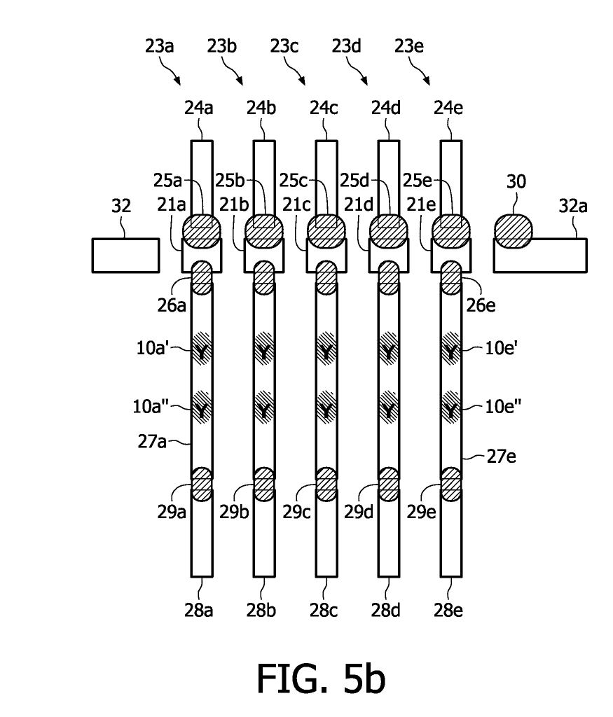

FIGS. 5a and 5b show a schematic top view of the first and second position a biochip according to a fifth embodiment of the present invention. This embodiment of a biochip according to the present invention comprises additionally to the embodiment illustrated by FIGS. 4a to 4d a set of detection probe reservoirs 28a, 28b, 28c, 28d, 28e and a set of third flow barriers 29a, 29b, 29c, 29d, 29e. To realize this, the first substrate 20 comprises five recess triplets 25a, 26a, 29a . . . , 25e, 26e, 29e having a first outer recess 25a, 25b, 25c, 25d, 25e, a middle recess 26a, 26b, 26c, 26d, 26e and a second outer 29a, 29b, 29c, 29d, 29e recess and the second substrate 22 comprises at least one recess quartet 23a, 23b, 23c, 23d, 23e having a first middle recess 21a, 21b, 21c, 21d, 21e, a second middle recess 27a, 27b, 27c, 27d, 27e, a first outer recess 24a, 24b, 24c, 24d, 24e and a second outer recess 28a, 28b, 28c, 28d, 28e.

The recesses are thereby shaped and arranged to that effect that in a first position, the first outer recess 25a of a recess triplet 25a, 26a, 29a overlaps with the first middle recess 21a of one recess quartet 23a or the first outer recess 25b, 25c, 25d, 25e of a recess triplet 25b, 26b, 29b . . . , 25e, 26e, 29e overlaps with the first middle recesses 21a, 21b, 21c, 21d, 21e of two neighboring recess quartets 23a, 23b, 23c, 23d, 23e, forming the isoelectric focusing channel 1.

FIG. 5b shows that in the second position, the first outer recess 25a, 25b, 25c, 25d, 25e of a recess triplet 25a, 26a, 29a . . . , 25e, 26e, 29e overlaps with the first outer recess 24a, 24b, 24c, 24d, 24e and the first middle recess 21a, 21b, 21c, 21d, 21e of a recess quartet 23a, 23b, 23c, 23d, 23e, whereas the middle recess 26a, 26b, 26c, 26d, 26e of the recess triplet 25a, 26a, 29a . . . , 25e, 26e, 29e overlaps with the first middle recess 21a, 21b, 21c, 21d, 21e and the second middle recess 27a, 27b, 27c, 27d, 27e of the recess quartet 23a, 23b, 23c, 23d, 23e, whereas the second outer recess 29a, 29b, 29c, 29d, 29e of the recess triplet 25a, 26a, 29a . . . , 25e, 26e, 29e overlaps with the second middle recess 27a, 27b, 27c, 27d, 27e and the second outer recess 28a, 28b, 28c, 28d, 28e of the recess quartet 23a, 23b, 23c, 23d, 23e, forming five chambers.

The first outer 24a, 24b, 24c, 24d, 24e, the second middle 27a, 27b, 27c, 27d, 27e and the second outer 28a, 28b, 28c, 28d, 28e recess of a recess quartet 23a, 23b, 23c, 23d, 23e thereby serves as buffer chamber, detection chamber and detection probe reservoir, respectively.

Similar to embodiment illustrated in FIGS. 4a to 4d, the recesses in this embodiment are arranged along axes. Thereby, the first outer recesses 25a, 25b, 25c, 25d, 25e, the middle recesses 26a, 26b, 26c, 26d, 26e and the second outer recesses 29a, 29b, 29c, 29d, 29e of the recess triplets 25a, 26a, 29a . . . , 25e, 26e, 29e are arranged along a first. a second axis and seventh axis, respectively, whereas the first, second and seventh axes are parallel to each other. Moreover, the first middle recess 21a, 21b, 21c, 21d, 21e, the second middle recess 27a, 27b, 27c, 27d, 27e, the first outer recess 24a, 24b, 24c, 24d, 24e and the second outer recess 29a, 29b, 29c, 29d, 29e of a recess quartet 23a, 23b, 23c, 23d, 23e are arranged along a third axis, whereas the third axes of several recess quartets 23a, 23b, 23c, 23d, 23e are parallel to each other.

Thereby, the first middle recesses 21a, 21b, 21c, 21d, 21e, the first outer recesses 24a, 24b, 24c, 24d, 24e, the second middle recesses 27a, 27b, 27c, 27d, 27e and the second outer recess 29a, 29b, 29c, 29d, 29e of several recess quartets 23a, 23b, 23c, 23d, 23e are arranged along a forth, a fifth axis, a sixth or an eighth axis, respectively, whereas the forth, the fifth, the sixth and the eighth axis are parallel to each other and form the same angle, in particular a rectangular angle, with the third axes.

In the first position, the first axis is arranged parallel above or under the forth axis and in the second position, the axis through the recesses of a recess triplet 25a, 26a, 29a . . . , 25e, 26e, 29e is parallel above or under the third axis. The switch between the first and the second position is thereby also achieved by displacing the first substrate 20 with respect to the second substrates 22 for a certain distance, for example corresponding to the width of the first recess in the direction the first axis, along the first or rather forth axis and for another certain, for example corresponding to half the width of the first recess in the direction of the third axis, along the third axis.

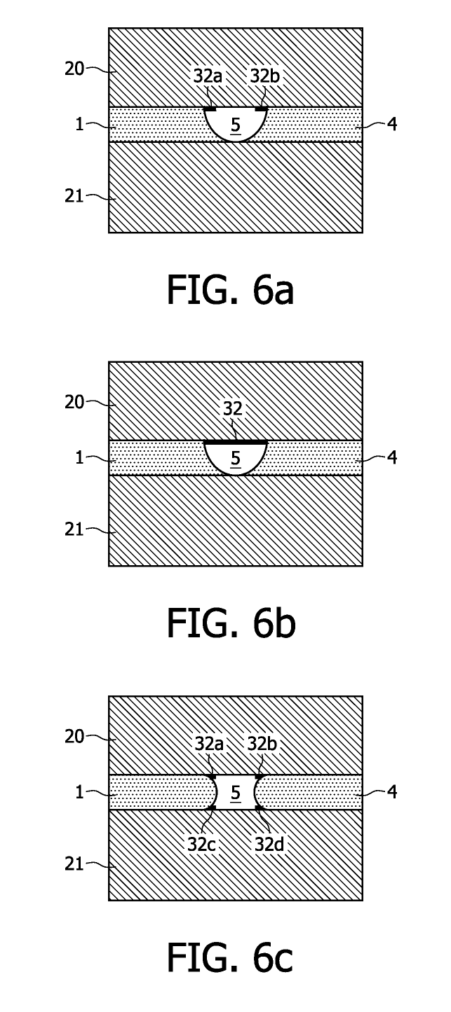

FIGS. 6a to 6c show schematic cross-sectional views of a hydrophobic stop barrier 5 according to the present invention. As illustrated by FIGS. 6a to 6c, a liquid, such as the sample, a fraction of the sample or a buffer or a liquid comprising a detection probe or a gel formulation, can be stopped by applying a linear 32a-32d or two-dimensional 32 water repellant coatings to one or several inner sides of a capillary. This effect can advantageously be used for realizing hydrophobic stop barriers 5, 6, 9.

1. A biochip for fractionating and detecting analytes comprising
an isoelectric focusing channel (1) having a pH gradient between a first pH value (pH1) and a second pH value (pH2),
an anode-cathode pair (12, 13), whereas the isoelectric focusing channel (1) is at least partially arranged between the anode (12) and the cathode (13) of the anode-cathode (12, 13),
a microfluidic sample channel (2) connected or connectable to the isoelectric focusing channel (1), and
at least one detection unit (3), comprising
a microfluidic buffer reservoir (4),
a first (5) and a second (6) flow barrier, and
a microfluidic detection chamber (7),
whereas the isoelectric focusing channel (1) is connectable to the buffer reservoir (4) by opening the first flow barrier (5) and to the detection chamber (7) by opening the second flow barrier (6), whereas the first (5) and the second (6) flow barrier are arranged on opposite sides of the isoelectric focusing channel (1).

2. A biochip according to claim 1, characterized in that the isoelectric focusing channel (1) is provided with an anode (12) and a cathode (13) inlet.

3. A biochip according to claim 1, characterized in that the width of the isoelectric focusing channel (1) varies along the pH gradient and symmetrically to the axis of the pH gradient, whereas the isoelectric focusing channel (1) has a greater width at pH ranges where a high amount of analytes is concentrated by isoelectric focusing and has a smaller width at pH ranges where a low amount of analytes is concentrated by isoelectric focusing.

4. A biochip according to claim 1, characterized in that the detection chamber (7) comprises at least one capture probe (10) immobilized to the wall of the detection chamber (7).

5. A biochip according to claim 1, characterized in that the detection chamber (7) comprises a plurality of different capture probes (10a′, 10a″, 10a′″, 10a″″).

6. A biochip according to claim 1 characterized in that the detection unit (1) further comprises a detection probe reservoir (8), whereas the detection probe reservoir (8) is connectable via a third flow barrier (9) to the detection chamber (7).

7. A biochip according to claim 1, characterized in that
the detection chamber (7) comprises at least one detection probe (11), and/or
the buffer reservoir (4) comprises at least one buffer or at least one buffer and at least one detection probe (11), and/or
the detection probe reservoir (8) comprises at least one detection probe (11).

8. A biochip according to claim 1 characterized in that the sample channel (2) and/or the buffer reservoir (4) and/or the detection chamber (7) and/or the detection probe reservoir (8) is provided with an inlet and/or a further flow barrier.

9. A biochip according to claim 1, characterized in that the biochip comprises a plurality of detection units (3a, 3b, 3c, 3d, 3e) positioned at different pH ranges of the pH gradient of the isoelectric focusing channel (1).

10. A biochip according to claim 1, characterized in that biochip comprises a set of capture (10) and detection (11) probes distinguishing between different post-translational modifications of an analyte and/or specific for several proteins and/or enzymes belonging to a certain signaling pathway.

11. A biochip according to claim 1, characterized in that the biochip comprises a first 20 and a second substrate 22, whereas the first substrate (20) is slidably abutting the second substrate (22), whereas the channel/s, reservoir/s, chamber/s and flow barriers of the biochip are realized at least partially by recesses in the abutting faces of the first (20) and the second (22) substrate, whereas the flow barriers are openable and closable by shifting one of the substrates (20, 22) with respect to the other from a first to a second position.

12. A biochip according to claim 1, characterized in that
the first substrate (20) comprises at least one recess pair (25a, 26a, . . . , 25e, 26e) having a first (25a, 25b, 25c, 25d, 25e) and a second (26a, 26b, 26c, 26d, 26e) recess,
whereas the second substrate (22) comprises at least one recess triplet (23a, 23b, 23c, 23d, 23e) having a middle recess (21a, 21b, 21c, 21d, 21e), a first outer recess (24a, 24b, 24c, 24d, 24e) and a second outer recess (27a, 27b, 27c, 27d, 27e),
whereas the recesses are shaped and arranged to that effect that
in a first position, the first recess (25a, 25b, 25c, 25d, 25e) of a recess pair (25a, 26a, . . . , 25e, 26e) overlaps with the middle recess (21a, 21b, 21c, 21d, 21e) of one recess triplet (23a, 23b, 23c, 23d, 23e) or with the middle recesses (21a, 21b, 21c, 21d, 21e) of two neighboring recess triplets (23a, 23b, 23c, 23d, 23e), forming the isoelectric focusing channel (1), and
in a second position, the first recess (25a, 25b, 25c, 25d, 25e) of a recess pair (25a, 26a, 25e, 26e) overlaps with the first outer recess (24a, 24b, 24c, 24d, 24e) and the middle recess (21a, 21b, 21c, 21d, 21e) of a recess triplet (23a, 23b, 23c, 23d, 23e), whereas the second recess (26a, 26b, 26c, 26d, 26e) of the recess pair (25a, 26a, . . . , 25e, 26e) overlaps with the middle recess (21a, 21b, 21c, 21d, 21e) and the second outer recess (27a, 27b, 27c, 27d, 27e) of the recess triplet (23a, 23b, 23c, 23d, 23e), forming a chamber.

13. A biochip according to claim 1, characterized in that
the first substrate (20) comprises at least one recess triplet (25a, 26a, 29a . . . , 25e, 26e, 29e) having a first outer (25a, 25b, 25c, 25d, 25e), a middle (26a, 26b, 26c, 26d, 26e) and a second outer (29a, 29b, 29c, 29d, 29e) recess,
whereas the second substrate (22) comprises at least one recess quartet (23a, 23b, 23c, 23d, 23e) having a first middle recess (21a, 21b, 21c, 21d, 21e), a second middle recess (27a, 27b, 27c, 27d, 27e), a first outer recess (24a, 24b, 24c, 24d, 24e) and a second outer recess (28a, 28b, 28c, 28d, 28e),
whereas the recesses are shaped and arranged to that effect that
in a first position, the first outer recess (25a, 25b, 25c, 25d, 25e) of a recess triplet (25a, 26a, 29a . . . , 25e, 26e, 29e) overlaps with the first middle recess (21a, 21b, 21c, 21d, 21e) of one recess quartet (23a, 23b, 23c, 23d, 23e) or with the first middle recesses (21a, 21b, 21c, 21d, 21e) of two neighboring recess quartets (23a, 23b, 23c, 23d, 23e), forming the isoelectric focusing channel (1), and
in a second position, the first outer recess (25a, 25b, 25c, 25d, 25e) of a recess triplet (25a, 26a, 29a . . . , 25e, 26e, 29e) overlaps with the first outer recess (24a, 24b, 24c, 24d, 24e) and the first middle recess (21a, 21b, 21c, 21d, 21e) of a recess quartet (23a, 23b, 23c, 23d, 23e), whereas the middle recess (26a, 26b, 26c, 26d, 26e) of the recess triplet (25a, 26a, 29a 25e, 26e, 29e) overlaps with the first middle recess (21a, 21b, 21c, 21d, 21e) and the second middle recess (27a, 27b, 27c, 27d, 27e) of the recess quartet (23a, 23b, 23c, 23d, 23e), whereas the second outer recess (29a, 29b, 29c, 29d, 29e) of the recess triplet (25a, 26a, 29a . . . , 25e, 26e, 29e) overlaps with the second middle recess (27a, 27b, 27c, 27d, 27e) and the second outer recess (28a, 28b, 28c, 28d, 28e) of the recess quartet (23a, 23b, 23c, 23d, 23e), forming a chamber.

14. A biochip according to claim 1, characterized in that the first (20) and/or the second (22) substrate comprise each at least one inlet recess (30, 32) and/or inlet hole, whereas the inlet recesses (30, 32) and/or inlet holes are shaped and arranged to that effect that
in the first position,
the inlet recess (30) and/or inlet hole of the first substrate (20) overlaps
with the middle recess (21e) of the recess triplet (23e), positioned at one end of the channel formed in the first position, or
with the first middle recess (21e) of the recess quartet (23e), positioned at one end of the channel formed in the first position, and
the inlet recess (32) of the second substrate (22) overlaps
with the first recess (25a) of the recess pair (25a, 26a) positioned at the other end of the channel formed in the first position, or
with a first outer recess (25a) of a recess triplet (25a, 26a, 29a), which is positioned at the other end of the channel formed in the first position.

15. Use of a biochip according to claim 1 in
rapid and sensitive detection of proteins, protein-complexes, metabolites, glycoproteins, peptides, DNA, RNA, lipids, fatty acids, carbohydrates and/or other ampholytes in complex biological mixtures, such as blood, saliva, urine,
a testing chip, for example proteins, protein-complexes, metabolites, glycoproteins, peptides, DNA, RNA, lipids, fatty acids, carbohydrates and/or other ampholytes, for example for on-site (point-of-need) testing or for diagnostics in centralized laboratories or in scientific research,
a biosensor, in particular microfluidic biosensor, used for molecular diagnostics,
a high throughput screening chip for chemistry, pharmaceuticals or molecular biology,
a protein diagnostic biochip for cardiology, infectious diseases, new born screening, oncology, food, environment and/or metabolomics, and/or
a biochip for the detection and quantitation of proteins with posttranslational modifications and/or ratios between modified and unmodified species of the same protein.
